(19) United States
(12) Patent Application Publication
(10) Pub. No.: US 2015/0042188 A1
(43) Pub. Date: Feb. 12, 2015

(54) ELECTRIC MACHINE HAVING A PHASE SEPARATOR

(71) Applicant: Siemens Aktiengesellschaft, München (DE)

(72) Inventors: Willi Lutz, Wolframs-Eschenbach (DE); Norbert Schönbauer, Bad Fussing (DE)

(73) Assignee: Siemens Aktiengesellschaft a corporation

(21) Appl. No.: 14/384,597

(22) PCT Filed: Mar. 13, 2013
(86) PCT No.: PCT/EP2013/055140

§ 371 Date: Sep. 11, 2014

(30) Foreign Application Priority Data
Mar. 16, 2012 (DE) 102012204197.4

(51) Int. Cl. H02K 3/38; H02K 3/24; H02K 3/12

(52) U.S. Cl. CPC H02K 3/38; H02K 3/12; H02K 3/24
USPC 310/59; 310/208; 310/207

(57) ABSTRACT

The invention relates to an air-cooled dynamoelectric machine (1), in particular for low voltage<1000 V, comprising a stator (2), grooves (10) extending axially and facing a stator bore (9), in which grooves a multi-phase winding system is arranged, which forms a winding head (7) at each end face of the stator (2), wherein a phase separator (8) is provided between the different phases of the winding system in the winding head (7), wherein the phase separator (8) comprises two layers, with spacing elements (11) lying therebetween.

The invention relates to an air-cooled dynamoelectric machine, in particular for low voltage<1000 V, having a stator, with grooves extending axially and facing a stator bore, in which grooves a multiphase winding system is arranged, which forms a winding head at each end face of the stator, a phase separator being provided between the different phases of the winding system in the winding head.

To protect the insulation of the winding system of a dynamoelectric machine and additionally to abide by the maximum lubricant temperature of the bearings, dynamoelectric machines are cooled. Thanks to this cooling the waste heat arising in the electric machine is dissipated. The more effective the heat dissipation from the dynamoelectric machine, the smaller the electric machine can be, with the same power output.

In particular with low voltage machines an extremely compact construction is preferred on account of the limited installation dimensions. In this case the winding heads of low voltage machines have round-wire winding, which is wound very tightly to minimize the use of material and to make the construction volume compact. After the impregnation of the winding in the grooves and of the winding head, the winding head forms a solid resin-filled unit through which no cooling air can pass.

In winding heads of this type, heat sources hence regularly occur, which limit the thermal utilization of the dynamoelectric machine. Since additionally the conductors of different electrical phases in the winding head lie directly next to one another and the insulation of the individual conductors is not sufficient to guarantee the insulation capability between two phases, additional phase separators must also be incorporated into the winding head at the boundaries between the conductors.

DE 195 44 699 A1 describes an electric machine with an indirectly cooled stator winding, in which filler blocks are provided through the winding head formed by winding bars, and restrict the free passage areas between circumferentially adjacent winding bars such that the cooling gas is purposefully guided at the broad sides of the winding bars.

A disadvantage of this is that because of additional filler blocks the passage areas are restricted and because of winding bars cooling channels are more likely to arise. However, this is no longer the case with a cast winding head.

From DE 20 37 829 a cooling device for low-voltage dynamoelectric machines with cooling plates inlaid into the winding is known, the cooling plates being inlaid as phase separator templates between the individual winding layers in the winding head, consisting of readily thermoconductive material with electrically good surface insulation, projecting out of the winding head and being designed such that the part of the template projecting out of the winding head is divided into several sections which are bent in a direction which is favorable for the flow of coolant.

A disadvantage of this is that an additional transfer of heat is created, so that the heat must first be routed on via the separator templates onto the cooling plate and from there to the projecting parts of the template, in order only then to be absorbed by the coolant flow.

From U.S. Pat. No. 7,859,146 B2 a dynamoelectric machine is known, in which cooling channels extend in the winding head, but make no contribution to the phase separation.

Based on this, the object on which the invention is based is to create an air-cooled dynamoelectric machine which is compact in construction and easy to manufacture and features optimum thermal utilization of the entire dynamoelectric machine.

The said object is achieved in that the phase separator is designed to be double-layered, with spacing elements lying therebetween.

Thus passage areas for cooling air are now created in the winding head, in particular in the case of low-voltage machines, which significantly improve the heat dissipation from the hot-spots of the winding head. The thermal limitation of the dynamoelectric machine is normally predetermined by the winding head, but as a result the active part, in other words the stator with its winding system, cannot generally be fully utilized.

According to the invention the utilization of the active part is now increased, so that with the same construction volume of the dynamoelectric machine comparatively more power can be drawn from the machine, without raising the heat class of the dynamoelectric machine.

The increased power relates firstly to the drive power in a dynamoelectric machine designed as an electric motor and to the electrical power output in the case of a generator.

In one embodiment the spacing elements between the two layers of the phase separator are advantageously designed to be wave-shaped. It is particularly advantageous here if these waves are aligned such that the flow direction of the cooling air extends perpendicularly to the wave course. This means the cooling air flow encounters comparatively little flow resistance and the cooling air passing through the winding head per volume unit can be increased. This raises the cooling efficiency in the winding head.

The invention is particularly advantageously employed in low-voltage machines<1000 V, in which the winding system consists of round wires which are then additionally impregnated with a resin. Thus even when this type of machine has a compact structure there is sufficient cooling in the winding head region and the entire active part is optimally utilized.

The phase separators, which must ensure insulation between adjacent phases of the dynamoelectric machine in the winding head region, are here designed to be single-, double- or multi-layered. In this case the insulation thickness of the phase separators is if necessary adjusted to the insulation of the round wires, in particular to a varnish insulation, in that with sufficient insulation of the round wires at least one layer of a phase separator can be designed with reduced thickness.

Thus the whole insulation system of the dynamoelectric machine is optimized in terms of insulation technology, as well as in terms of thermal engineering.

In another embodiment the wave-shaped spacing elements have additional transverse openings 14 in their walls, in order to create additional turbulences in the flow channel which further increase the cooling power.

Advantageously in this case both the layers of the phase separator are manufactured from one material integrally with the spacing elements lying therebetween. This reduces the manufacturing costs.

In an alternative embodiment to this, the phase separators and the spacing elements lying therebetween also consist of different materials. Thus the insulation technology requirements are assumed by the layers, and the cooling technology requirements by the spacing elements, which here among other things oppose the cooling air flow with a particularly low level of friction.

The phase separators are made of a material which satisfies both the requirements for electrical insulation between the phases and those for thermal conductivity.

The invention and other advantageous embodiments of the invention can be taken from the following schematic drawings, in which:

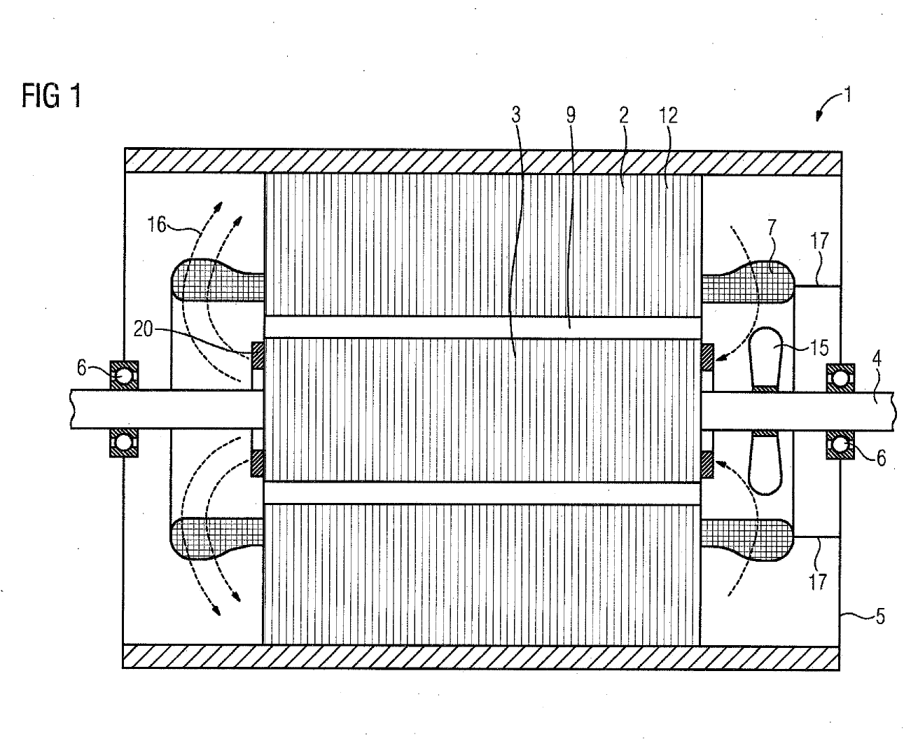

FIG. 1 shows a schematic longitudinal section of a dynamoelectric machine.

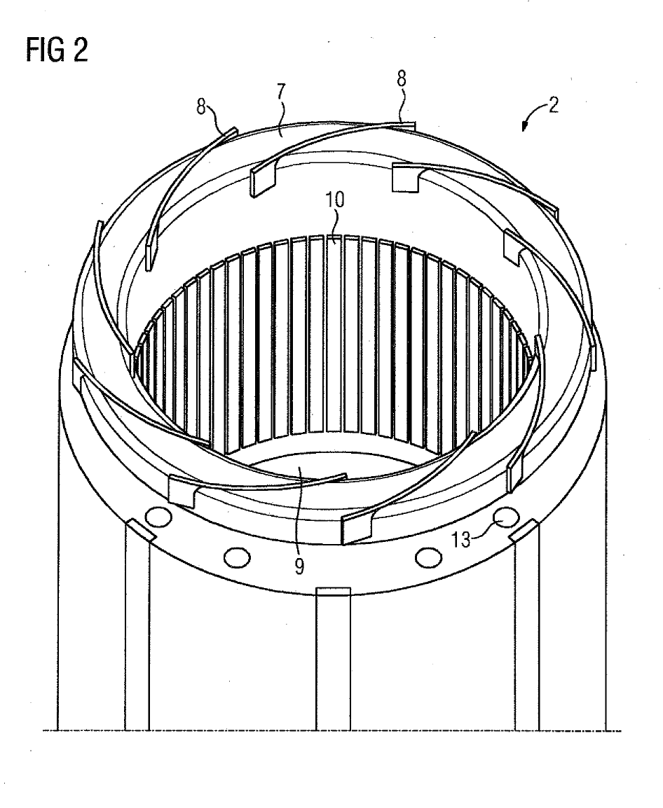

FIG. 2 shows a perspective illustration of a stator.

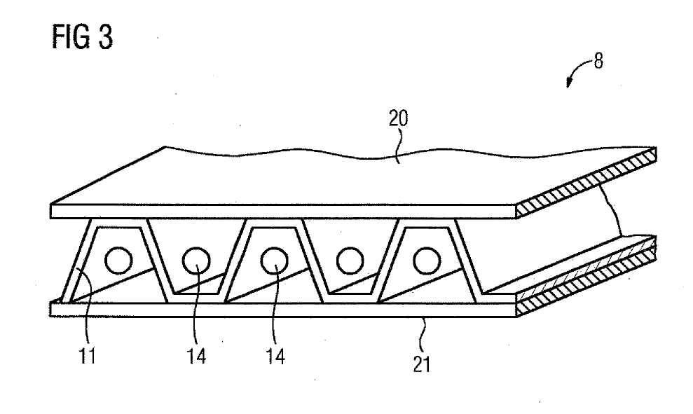

FIG. 3 shows the inventive phase separator.

FIG. 1 shows a dynamoelectric machine 1, having a stator 2. The stator 2 has grooves 10 extending axially and facing the stator bore 9, a winding system, in particular made from round wires, being provided in the grooves 10, and forming winding heads 7 at the end faces of the stator 2. The winding heads 7 limit the utilization of the dynamoelectric machine 1, since local regions exhibiting a temperature rise—known as hot-spots—occur in the resin-impregnated winding system and in particular in the winding heads 7, and during operation of the electric machine 1 impose an upper limit on the thermal utilization of the machine.

Located inside the stator bore 9, separated from the stator 2 by an air gap, is a rotor 3, which like the stator 2 is constructed of plates 12. In the specific case the rotor is a rotor 3 with a squirrel-cage winding, the short-circuit ring of the squirrel-cage winding being indicated merely schematically.

The stator 2 is located inside a housing 5, this housing being retained by way of bearings 6 on a shaft 4, the shaft 4 being connected to the rotor 3 in a rotationally fixed manner.

The present case relates to a dynamic electric machine 1 with an internal cooling circuit, i.e. a cooling air flow 16 flowing inside the housing 2 is maintained by a fan 15 or else by fan blades on the short-circuit ring 20. Recooling of this cooling air flow inside the housing 2 is achieved by cooling ribs in the housing 5 or by liquid cooling, which is arranged in the housing 5 as a cooling sleeve (not shown in greater detail).

In particular now to cool the hot-spots of the winding head 7 the cooling air flow is essentially guided through the winding head 7, by the phase separator 8 being designed such that spacing elements 11 are located between two layers of the phase separator 8, and are advantageously aligned such that the cooling air flow 16 flows through in a simple manner.

In order to force the cooling air flow 16 to flow through the winding head 7 in terms of flow technology, in another embodiment certain regions inside the housing 5 of the electric machine 1, which form a flow-technology bypass, have been provided with guide appliances 17. Thus the cooling air flow 16 is forced through the winding head 7.

FIG. 2 shows a perspective illustration of the stator 2 with its grooves 10 facing the stator bore 9. Formed on the end face of the stator 2 is a winding head 7, different phases of the thermodynamic machine 1 being electrically separated from one another by the phase separator 8, in order to maintain the necessary insulation resistance of the thermodynamic machine 1. Furthermore, the cooling channels 13 can be inferred from the stator 2, which together with axially extending cooling channels (not shown in greater detail) in the rotor 3 maintain a cooling circuit 16 inside the electric machine 1.

This electric machine need not necessarily be a dynamoelectric machine 1 with an internal cooling circuit. The inventive idea of providing the phase separators 8 with spacing elements 11 can also be employed in open-circuit ventilated dynamoelectric machines. Thanks to a corresponding guide appliance it need only be ensured that the cooling air flow at least partially penetrates the winding head 7.

Advantageous here are the spacing elements 11, which are preferably arranged in a wave-shaped manner such that the waves extend perpendicular to the flow direction, so that the individual waves impede the flow a little, but at the same time also ensure an enlargement of the heat-dissipating surface.

The wave shape of the spacing elements 11 designed to be wave-shaped is here viewed in the direction of the cooling air flow, as a sinusoidal, rectangular or trapezoidal course.

To create a turbulence in the cooling air flow inside the winding head 7, transverse openings 14 are preferably provided inside the walls of the spacing elements 11. Turbulent air—in other words a turbulent air flow—can absorb more heat from the winding head region.

Advantageously the phase separator 8 is manufactured integrally from one material. In other words, both the individual layers 20, 21 and the spacing elements 11, which in the present case are designed to be wave-shaped, are manufactured from one material and are thus referred to as integral.

In another embodiment the layers 20, 21 and the spacing elements can both consist of different materials.

Advantageously in this case the individual layers of the phase separator 8 as well as the spacing elements 11 have good thermal conductivity, in order to dissipate the heat out of the winding head region which is formed by the impregnated round wires. In this case the layers 20, 21 are predominantly responsible for the insulation of the phases in the winding head.

1.-7. (canceled)

8. An air-cooled dynamoelectric machine, comprising:
a stator having a stator bore and axial grooves facing the stator bore;
a multiphase winding system arranged in the grooves and configured to form a winding head at each end face of the stator; and
a phase separator provided between different phases of the winding system in the winding head, said phase separator having two layers and spacing elements lying between the two layers.

9. The air-cooled dynamoelectric machine of claim 8, constructed for low voltage<1000 V.

10. The air-cooled dynamoelectric machine of claim 8, wherein the spacing elements have a wave-shaped configuration.

11. The air-cooled dynamoelectric machine of claim 8, wherein the spacing elements are aligned between the layers of the phase separator to establish an essentially radially extending cooling air flow in the winding head.

12. The air-cooled dynamoelectric machine of claim 8, wherein the winding system is constructed from round wires.

13. The air-cooled dynamoelectric machine of claim 12, wherein the round wires are provided with at least one varnish insulation.

14. The air-cooled dynamoelectric machine of claim 8, wherein the spacing elements have walls provided with transverse openings.

15. The air-cooled dynamoelectric machine of claim 8, wherein the layers of the phase separators and the spacing elements are made of an insulating, single-piece material.
